(19) United States
(12) Patent Application Publication
(10) Pub. No.: US 2024/0365353 A1
(43) Pub. Date: Oct. 31, 2024

(54) SYSTEMS AND METHODS FOR SIDELINK POSITIONING

(71) Applicant: ZTE Corporation, Shenzhen (CN)

(72) Inventors: Junpeng LOU, Shenzhen (CN); Chuangxin JIANG, Shenzhen (CN); Mengzhen LI, Shenzhen (CN); Jie CHEN, Shenzhen (CN); Focai PENG, Shenzhen (CN); Haigang HE, Shenzhen (CN)

(73) Assignee: ZTE Corporation, Shenzhen (CN)

(21) Appl. No.: 18/767,381

(22) Filed: Jul. 9, 2024

Related U.S. Application Data
(63) Continuation of application No. PCT/CN2023/073440, filed on Jan. 20, 2023.

(51) Int. Cl. H04W 72/40; H04L 5/00; H04W 72/25

(52) U.S. Cl. CPC H04W 72/40; H04L 5/0051; H04W 72/25

(57) ABSTRACT

The present disclosure relates to sending, by a first wireless communication device to a second wireless communication device, a message. The message can be used for the second wireless communication device to determine, from a resource pool, respective frequency-domain resources and/or time-domain resources of one or more Sidelink Positing Reference Signals (SL-PRSs).

### CROSS-REFERENCE TO RELATED APPLICATION

This application claims the benefit of priority under 35 U.S.C. § 120 as a continuation of International Patent Application No. PCT/CN2023/073440, filed on Jan. 20, 2023, the disclosure of which is incorporated herein by reference in its entirety.

### TECHNICAL FIELD

The disclosure relates generally to wireless communications and, more particularly, to sidelink positioning.

### BACKGROUND

Sidelink (SL) communication refers to wireless radio communication between two or more User Equipments (UEs). In this type of communications, two or more UEs that are geographically proximate to each other can communicate without being routed to a Network (e.g. Base Station (BS)) or a core network. Data transmissions in SL communications are thus different from typical cellular network communications that include transmitting data to a Network and receiving data from a Network. In SL communications, data is transmitted directly from a source UE to a target UE through, for example the Unified Air Interface (e.g., PC5 interface) without passing through a Network.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to sending, by a first wireless communication device (e.g., TX UE) to a second wireless communication device (e.g., RX UE), a message. The message can be used for the second wireless communication device to determine, from a resource pool, respective frequency-domain resources and/or time-domain resources of one or more Sidelink Positing Reference Signals (SL-PRSs).

In some arrangements, a pattern of the one or more SL-PRSs can be (pre-)configured in one of the following layers: Radio Resource Connection (RRC) layer, Sidelink Sidelink Positioning Protocol (SLPP), PC5 Radio Resource Control (PC5-RRC), PC5 Signalling (PC5-S), Medium Access Control (MAC) layer, or Application layer.

In some arrangements, the message may contain one or more Sidelink Control Information (SCI) messages. The one or more SCI messages can be used to indicate the frequency-domain resources and/or time-domain resources of the SL-PRSs, the frequency-domain resource and/or time-domain resource of at least one of the SL-PRSs to be punctured, residual frequency-domain resources and/or residual time-domain resources of the SL-PRSs after being punctured, or frequency-domain resources and/or time-domain resources of PSSCH.

In some arrangements, transmission candidate locations of the one or more SCI messages can be mapped to locations of the respective frequency-domain resources and/or time-domain resources of the one or more SL-PRSs. A transmission candidate location of at least one of the one or more SCI messages can be (pre-)configured. The one or more SL-PRSs can be Frequency Domain Multiplexed. The one or more SCI messages may explicitly configure the respective frequency-domain and/or time-domain resources of the SL-PRSs. The respective frequency-domain resources of the SL-PRSs, configured by the one or more SCI messages, may include at least one of: one or more RE offsets, one or more symbol/slot offsets, one or more sub-channel offsets, or one or more frequency indices.

In some arrangements, the one or more SCI messages may implicitly configure the respective frequency-domain and or time-domain resources of the SL-PRSs. The one or more SCI messages may have a (pre-)configured mapping with the frequency-domain and/or time-domain resources of the SL-PRSs.

In some arrangements, the message can be (pre-)configured to determine one of a plurality of patterns (pre-)configured for the plurality of SL-PRSs. The patterns can be (pre-) configured in one of the following layers: RRC layer, SLPP, PC5-RRC, PC5-S, MAC layer, or Application layer. The message may contain one or more Sidelink Control Information (SCI) messages. The one or more SCI messages may explicitly configure the respective frequency-domain and/or time-domain resources of the SL-PRSs. The respective frequency-domain resources of the SL-PRSs, configured by the one or more SCI messages, may include at least one of: one or more RE offset lists, one or more sub-channel offset lists, or one or more frequency index lists.

In some arrangements, the one or more SCI messages may implicitly configure the respective frequency-domain and/or time-domain resources of the SL-PRSs. The one or more SCI messages may have a (pre-)configured mapping with the frequency-domain and/or time-domain resources of the SL-PRSs. The frequency-domain resources of the SL-PRSs can be identical to each other.

In some arrangements, a list of respective bandwidths of the plurality of SL-PRSs can be (pre-)configured in one of the following layers: RRC layer, SLPP, PC5-RRC, PC5-S, MAC layer, or Application layer. The message can be (pre-)configured to indicate a corresponding one of the bandwidths for each of the SL-PRSs. The message may contain one or more sidelink control information (SCI) messages.

In some arrangements, the frequency-domain resources of the SL-PRSs can be each continuous or discontinuous, with a granularity being in a unit of resource elements, resource blocks, sub-channels, or interlace indices. A difference between a time-domain resource of each of the SL-PRS and a time-domain resource of a corresponding PSSCH transmission carrying SL-PRS related information can be limited. The SL-PRS related information may include at least one of SL-PRS configuration information, and/or SL-PRS measurement results.

In some arrangements, the message can be further used to indicate whether to puncture the frequency-domain resource and/or time-domain resource for reception or transmission of the at least one SL-PRS. The punctured frequency-domain resource and/or time-domain resource can be determined by at least one of the first wireless communication device, the second wireless communication device, or a third wireless communication device different from the first wireless communication device or the second wireless communication device.

In some arrangements, the message can be further (pre-)configured to indicate puncturing information. The puncturing information may include at least one of: a puncturing indicator, a puncturing type, a puncturing number, a puncturing frequency length, a puncturing frequency start, a puncturing time length, a puncturing time start, a puncturing offset, a puncturing Time-Domain Resource Indication Value (TRIV), a puncturing Frequency-Domain Resource Indication Value (FRIV), a puncturing ask, a puncturing resource location indicator, or a puncturing report. The puncturing information can be determined by the first wireless communication device, or a third wireless communication device different from the first wireless communication device or the second wireless communication device.

In some arrangements, a location of the frequency-domain resource and/or time-domain resource of the at least one SL-PRS to be punctuated can be configurable or (pre-)configured. The residual frequency-domain resources and/or the residual time-domain resources of the SL-PRSs after being punctured can be (pre-)configured to be received by the second wireless communication device. A total power for sending the at least one SL-PRSs can be constant in one slot or one occasion. A power for sending the at least one SL-PRS per each resource element/resource block/subchannel/sub-band can be constant in one slot or one occasion.

Some arrangements of the present disclosure relate to systems, methods, apparatuses, and non-transitory computer-readable media relating to receiving, by a second wireless communication device from a first wireless communication device, a message. The message can be used for the second wireless communication device to determine, from a resource pool, respective frequency-domain resources and/or time-domain resources of one or more Sidelink Positing Reference Signals (SL-PRSs).

In some arrangements, the message may contain one or more Sidelink Control Information (SCI) messages. The one or more SL-PRSs can be Frequency Domain Multiplexed.

In some arrangements, the first wireless communication device may receive/sense based on respectively multiplexed indices from at least one of the messages. The first wireless communication device may select/report the resources of at least one SL-PRS. The second wireless communication device may receive at least one of the one or more SL-PRSs based on respectively multiplexed indices. The second wireless communication device may receive the at least one SL-PRS.

In some arrangements, the one or more SCI messages can be used to indicate the frequency-domain resources and/or time-domain resources of the SL-PRSs, the frequency-domain resource and/or time-domain resource of at least one of the SL-PRSs to be punctured, residual frequency-domain resources and/or residual time-domain resources of the SL-PRS after punctured, or frequency-domain resources and/or time-domain resources of PSSCH. The second wireless communication device may receive another SCI message based on at least one of the one or more SCI messages, and/or based on a report sent by a third wireless communication device, from the third wireless communication device. The second wireless communication device may receive the at least one SL-PRS.

In some arrangements, the first wireless communication device may receive/sense based on respectively information (including puncturing information) from at least one of the messages. The first wireless communication device may select/report the resources of at least one SL-PRS.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communication, according to various arrangements.

FIG. 3 is a diagram illustrating an example sidelink positioning, according to various arrangements.

FIG. 4 is a diagram illustrating an example sidelink positioning, according to various arrangements.

FIG. 5 is a diagram illustrating an example sidelink positioning, according to various arrangements.

FIG. 6 is a diagram illustrating an example sidelink positioning, according to various arrangements.

FIG. 7 is a diagram illustrating an example sidelink positioning, according to various arrangements.

FIG. 8 is a diagram illustrating an example sidelink positioning, according to various arrangements.

FIG. 9 is a diagram illustrating an example sidelink positioning, according to various arrangements.

FIG. 10 is a diagram illustrating an example sidelink positioning, according to various arrangements.

FIG. 11 is a diagram illustrating an example sidelink positioning, according to various arrangements.

FIG. 12 is a diagram illustrating an example sidelink positioning, according to various arrangements.

FIG. 13 is a diagram illustrating an example sidelink positioning, according to various arrangements.

FIG. 14 is a diagram illustrating an example sidelink positioning, according to various arrangements.

FIG. 15 is a diagram illustrating an example sidelink positioning, according to various arrangements.

FIG. 16 is a diagram illustrating an example sidelink positioning, according to various arrangements.

FIG. 17 is a diagram illustrating an example sidelink positioning, according to various arrangements.

FIG. 18 is a diagram illustrating an example sidelink positioning, according to various arrangements.

FIG. 19 is a flowchart diagram illustrating an example method for sidelink positioning, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

To improve the reliability, data rate, latency of SL communications, Carrier Aggregation (CA) can be implemented for SL communications. In CA, two or more Component Carriers (CCs) are aggregated in order to support wider transmission bandwidths in the frequency domain. In some examples, a vehicle UE can simultaneously perform SL reception and transmission on one or multiple CCs. The arrangements disclosed herein relate to data split and data duplication based on CA.

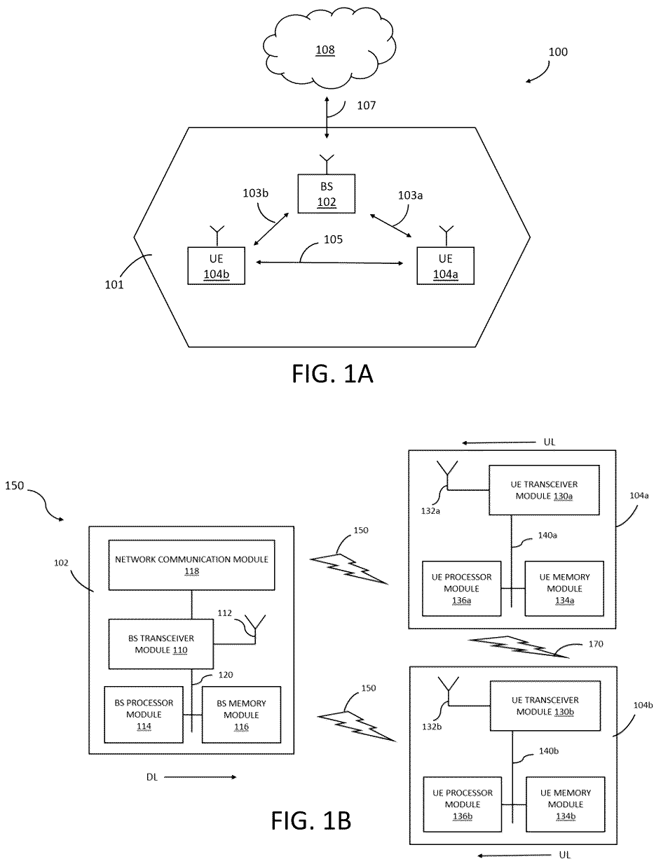

Referring to FIG. 1A, an example wireless communication network 100 is shown. The wireless communication network 100 illustrates a group communication within a cellular network. In a wireless communication system, a network side communication node or a Network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a Network 102 and UEs 104a and 104b, respectively. In some arrangements, the Network 102 and UEs 104a/104b are sometimes referred to as “wireless communication node” and “wireless communication device,” respectively. Such communication nodes/devices can perform wireless communications.

In the illustrated arrangement of FIG. 1A, the Network 102 can define a cell 101 in which the UEs 104a and 104b are located. The UEs 104a and/or 104b can be moving or remain stationary within a coverage of the cell 101. The UE 104a can communicate with the Network 102 via a communication channel 103a. Similarly, the UE 104b can communicate with the Network 102 via a communication channel 103b. In addition, the UEs 104a and 104b can communicate with each other via a communication channel 105. The communication channels 103a and 104b between a respective UE and the Network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The Network 102 is connected to Core Network (CN) 108 through an external interface 107, e.g., an Iu interface.

In some examples, a remote UE (e.g., the UE 104b) that does not directly communicate with the Network 102 or the CN 108 (e.g., the communication channel link 103b is not established) communicates indirectly with the Network 102 and the CN 108 using the SL communication channel 105 via a relay UE (e.g., the UE 104a), which can directly communicate with the Network 102 and the CN 108 or indirectly communicate with the Network 102 and the CN 108 via another relay UE that can directly communicate with the Network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the Network 102 and UEs 104a and 104b, as described in FIG. 1A. The Network 102 includes a Network transceiver module 110, a Network antenna 112, a Network memory module 116, a Network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The Network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the Network 102 is known as an uplink transmission, and a wireless transmission from an antenna of the Network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the Network transceiver module 110 may be herein referred to as a downlink transceiver, or Network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the Network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the Network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the Network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the Network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the Network 102 that enable bi-directional communication between Network transceiver 110 and other network components and communication nodes configured to communication with the Network 102. For example, the network interface 118 may be configured to support internet or WiMAX traffic. In a typical deployment, without limitation, the network interface 118 provides an 802.3 Ethernet interface such that Network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the Network 102 to communicate with other Network s or core network over a wired or wireless connection.

In some arrangements, each of the UEs 104a and 104b can operate in a hybrid communication network in which the UE communicates with the Network 102, and with other UEs, e.g., between 104a and 104b. As described in further detail below, the UEs 104a and 104b support SL communications with other UE's as well as downlink/uplink communications between the Network 102 and the UEs 104a and 104b. In general, the SL communication allows the UEs 104a and 104b to establish a direct communication link with each other, or with other UEs from different cells, without requiring the Network 102 to relay data between UEs.

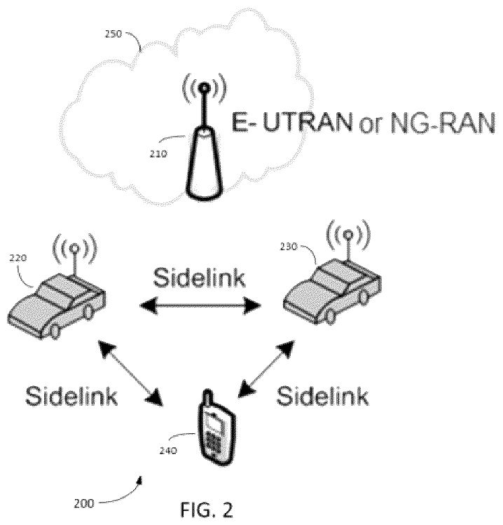

FIG. 2 is a diagram illustrating an example system 200 for SL communication, according to various arrangements. As shown in FIG. 2, a Network 210 (such as Network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

With the development of sidelink technology, there can be more reference signalings designed for sidelink in different technical directions. For example, a sidelink positioning reference signaling can be needed for sidelink positioning technology. A dedicated resource pool and/or a shared resource pool for sidelink positioning reference signal (SL-PRS) emerges in response to the demand. How to transmit and receive the SL-PRS (e.g., including a signal design, a resource allocation, a measurement, a hopping, or a repetition) in the dedicated resource pool and/or the shared resource pool is a significant and urgent problem. This disclosure is devoted to resolve the related problems.

There are several studies can be investigated as follows. A study of performance and feasibility of potential solutions for SL positioning may consider relative positioning, ranging, and/or absolute positioning (e.g., for RAN1, RAN2). To meet the identified accuracy requirements, bandwidth requirement evaluation may be needed (e.g., for RAN1). A study of positioning methods (e.g., time difference of arrival (TDOA), round trip time (RTT), angle of arrival (AOA) may include combination of SL positioning measurements with other RAT dependent positioning measurements (e.g., user plane (Uu) based measurements) (e.g., for RAN1). A study of sidelink reference signals for positioning purposes from physical layer perspective may include a signal design, a resource allocation, a measurement, an associated procedure, reusing existing reference signals, procedures (from sidelink communication or from positioning) (e.g., for RAN1). To enable sidelink positioning covering both UE based and network based positioning (e.g., RAN2, including coordination and alignment with RAN3 and SA2 as required), a study of positioning architecture and signaling procedures (e.g., configuration, measurement reporting) may be needed. When the bandwidth requirements have been determined and the study of sidelink communication in unlicensed spectrum has progressed, whether unlicensed spectrum can be considered in further work.

For each downlink PRS resource configured, a UE may assume that a sequence r (m) is scaled with a factor β_{PRS} and mapped to resources elements (k,l)_{p,μ} according to

$${a}_{k , l}^{( p , μ )} = {β}_{PRS} r ( m )$$

$$m = 0 , 1 , …$$

$$k = m {K}_{comb}^{PRS} + ( ( {k}_{offset}^{PRS} + {k}^{′} ) mod {K}_{comb}^{PRS} )$$

$$l = {l}_{start}^{PRS} , {l}_{start}^{PRS} + 1 , … , {l}_{start}^{PRS} + {L}_{PRS} - 1$$

When the following conditions are fulfilled:
i. the resource element (k,l)_{p,μ} is within the resource blocks occupied by the downlink PRS resource for which the UE is configured;
ii. the symbol l is not used by any synchronization signal/physical broadcast channel (SS/PBCH) block used by a serving cell for downlink PRS transmitted from the same serving cell or any SS/PBCH block from a non-serving cell whose time frequency location is provided to the UE by higher layers for downlink PRS transmitted from the same non-serving cell;
iii. the slot number satisfies certain conditions.

And wherein the antenna port p=5000; lₛₜₐᵣₜ^{PRS} is the first symbol of the downlink PRS within a slot and given by the higher-layer parameter dl-PRS-ResourceSymbolOffset; the size of the downlink PRS resource in the time domain L_{PRS}∈{2,4,6,12} is given by the higher-layer parameter dl-PRS-NumSymbols; the size of the downlink PRS resource in the time domain L_{PRS}∈{2,4,6,12} is given by the higher-layer parameter dl-PRS-NumSymbols; and the comb size K_{comb}^{PRS}∈{2, 4, 6,12} is given by the higher-layer parameter dl-PRS-CombSizeN-AndReOffset for a downlink PRS resource configured for RTT-based propagation delay compensation, otherwise by the higher-layer parameter dl-PRS-CombSizeN such that the combination {L_{PRS}, K_{comb}^{PRS}} is one of {2, 2}, {4, 2}, {6, 2}, {12, 2}, {4, 4}, {12, 4}, {6, 6}, {12, 6} and {12, 12}.

In some embodiments, a higher layer may mean/indicate at least one of a radio resource control (RRC) layer, sidelink positioning protocol (SLPP), PC5-RRC, PC5-S, MAC layer, or application layer. A physical layer may mean/indicate 1-st sidelink control information (SCI), 2-nd SCI, SCI for SL-positioning reference signal (PRS), or MAC CE.

### Implementation Example 1

For a resource pool to transmit a sidelink positioning reference signal (SL-PRS), a bandwidth of SL-PRS can be seem as the bandwidth of resource pool, or smaller than the bandwidth of resource pool. In certain embodiments, the bandwidth of SL-PRS can be seen/considered as the bandwidth of resource pool.

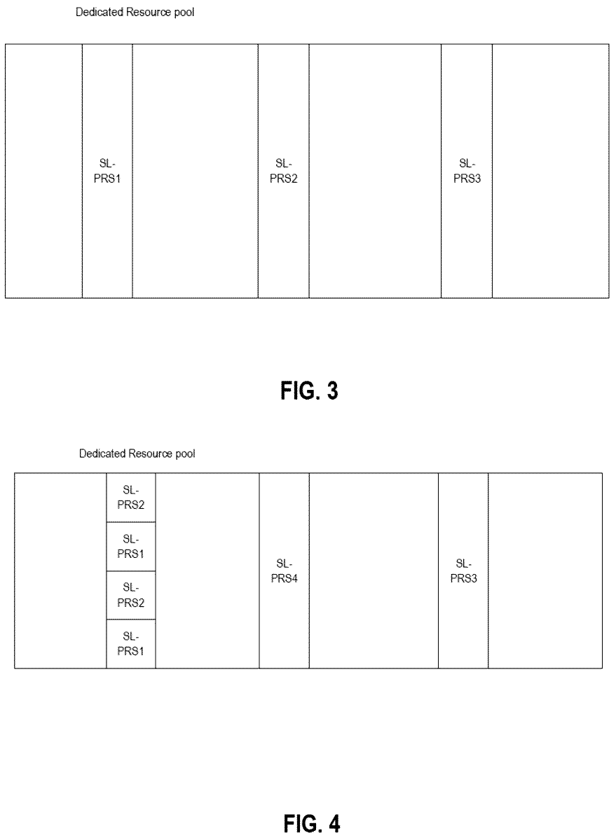

FIG. 3 is a diagram illustrating an example all bandwidth sidelink positioning reference signal, according to various arrangements. For an example of a dedicated resource pool, the SL-PRS can be transmitted and received with the same bandwidth with the resource pool (e.g., dedicated resource pool). For a procedure of a SL-PRS transmission and receipt (e.g., the bandwidth of the SL-PRS is same as the resource pool), parameters of the SL-PRS can be (pre-)configured from a higher layer. A lower layer may not indicate (a frequency of) the SL-PRS.

Furthermore, the SL-PRS can be transmitted with sidelink control information (SCI) indicating or without SCI indicating (e.g., the SCI can be in the dedicated resource pool or not). For example, the SL-PRS may transmit without SCI. All the parameters can be (pre-)configured from a higher layer, a bandwidth, a period, a priority, and/or a resource allocation. The other parameters for SL PRS can be (pre-)configured from the configuration of the resource pool or the frequency layer.

For mode 1, a configuration based on DCI 3 can be transmitted by a TRP. For mode 2, the configuration can be from a higher layer or (pre-)configured. In some embodiments, the SL-PRS can be transmitted periodic or aperiodic.

For another case, if the bandwidth of SL-PRS is smaller than the resource pool, the procedure can be also useful. For example, all the SL-PRS in the resource pool may have the same bandwidth, and the bandwidth can be the lowest or highest frequency domain in the resource pool.

### Implementation Example 2

In some embodiments, a bandwidth of a sidelink positioning reference signal (SL-PRS) can be same as a resource pool (e.g., dedicated resource pool). Some parameters of the SL PRS can be (pre-)configured or from a higher layer and some parameters can be from a lower layer (e.g., considering frequency division multiplexing (FDM) for some signals or channels).

For a shared resource pool, a physical sidelink shared channel (PSSCH) and a SL-PRS can be transmitted by FDM.

FIG. 4 is a diagram illustrating an example all bandwidth sidelink positioning reference signal frequency division multiplexing or comb pattern, according to various arrangements. For a dedicated resource pool, the procedure can be the same as the example of the FDM of different SL-PRSs. For a FDM scheme, the different SL-PRSs can be transmitted in the same time domain (e.g., SL-PRS1 and SL-PRS2 can be transmitted in the dedicated resource pool frequency domain).

A division of the frequency domain (including different frequency granularity (continues or discontinues)) can be (pre-)configured or from a higher layer, such as a comb pattern or a sub-channel pattern.

For different signals or channels in the same frequency domain, there can be two schemes to indicate sidelink positioning reference signal (SL-PRS). The two schemes can be indication displayed and implicit indication.

Scheme 1: Indication displayed, e.g., for a PRS comb pattern. The lower layer sidelink control information (SCI) may indicate a frequency offset, such as a resource element (RE) offset sub-channel offset or other frequency index by the bits of a SCI signal.

Scheme 2: Implicit indication. The candidate locations of a SCI transmission may imply a mapping SL-PRS frequency index.

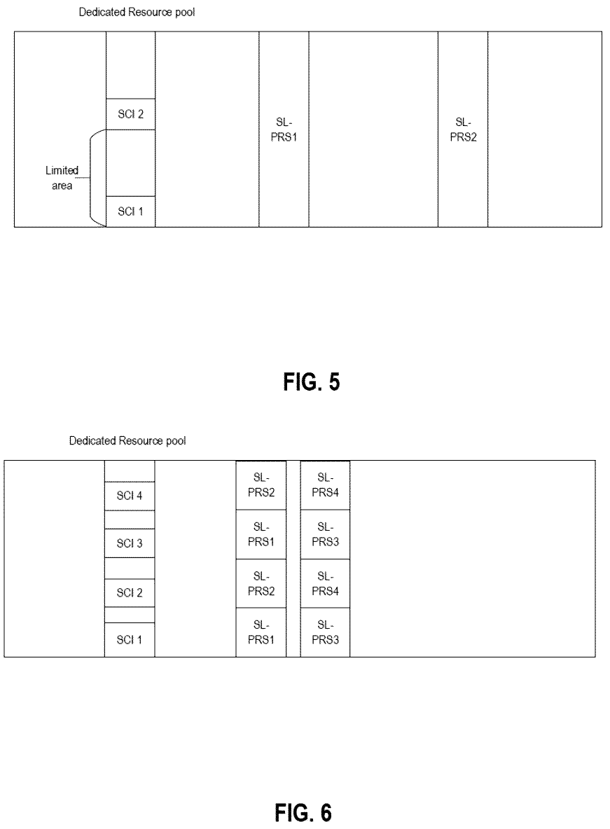

The SCI signal can be transmit same as the example of SL-PRS FDM (e.g., FIG. 5 and FIG. 6). FIG. 5 is a diagram illustrating an example different time domain SL-PRS (single port), according to various arrangements. FIG. 6 is a diagram illustrating an example different time and/or frequency domain SL-PRS (single port), according to various arrangements. For the dedicated resource pool, considering the complexity of blind detection of SCI, the SCI can be limited in a frequency domain. For example, there can be only one SCI in the limited area. The SCI may have fixed frequency locations.

Based on the conditions, for scheme 1 (indication displayed), there can be no limit that the time and frequency domain of SCI has fixed mapping relation with SL-PRS resource location. The SCI may obtain the time and frequency of the SL-PRS. For the FDM or comb pattern of the SL-PRS, the REoffset or other frequency index can be included in the SCI.

In FIG. 6, SCI 1 may contain/include resource information which can indicate the frequency and time domain of SL-PRS1.

For scheme 2 (implicit indication), a time and frequency domain of SCI may have fixed mapping relation with a SL-PRS resource location (e.g., FIG. 6). If the SCI 1 is transmitted in the fixed area, SL-PRS1 may be determined in the mapping area. In other words, if the resource of SL-PRS1 does not transmit any signal or channel of a UE, the UE may not transmit anything in the resource of SCI 1. The SCI transmission candidate location can be mapping with the SL-PRS transmission.

### Implementation Example 3 (Multi-Panel or Multi-Port)

In some embodiments, it can be beneficial to transmit the SL-PRS or other signal/channel through multi-panel or multi-port. Based on multi-panel of a UE, one anchor UE can be seen/identified/perceived as two anchor for positioning. For example, a time difference of arrival (TDOA) positioning method may have limit a minimum anchor number. The multi-panel or multi-port transmission can reduce the requirement of an anchor UE number.

In some embodiments, multi-panel or multi-port can reduce an effect of geometric dilution of precision (GDOP). Therefore, multi-panel or multi-port can be supported at least in SL positioning.

For a SL-PRS comb pattern, at least one comb can be support in a slot. The at least one comb can be (pre-)configured by a higher layer. A physical layer may indicate which comb(s) were used. The at least one comb pattern in a slot can be used for different ports, or panels.

For a multi-port transmission, the SL-PRS can be a FDM and/or a TDM. For example, a SL-PRS can be FDM in the dedicated resource pool. There can be also two schemes to indicate the SL-PRS. The two schemes can be indication displayed and implicit indication.

Scheme 1: Indication displayed (e.g., a PRS comb pattern). The lower layer SCI may indicate a frequency offset list, such as a resource element (RE) offset list, sub-channel offset list or other frequency index list by the bits of a SCI signal.

Scheme 2: Implicit indication. The frequency of a SCI transmission may imply a mapping SL-PRS frequency index list.

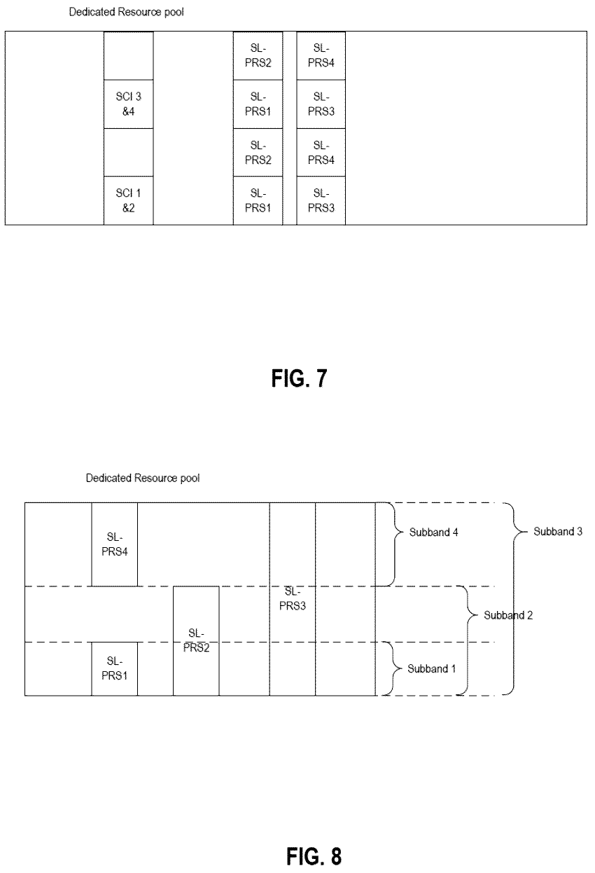

The SCI signal can be transmit same as the example of SL-PRS FDM (e.g., FIG. 7). FIG. 7 is a diagram illustrating an example multi-panel SL-PRS with FDM SCI, according to various arrangements. For the dedicated resource pool, considering the complexity of blind detection of SCI, the SCI can be limited in a frequency domain. For example, there can be only one SCI in the limited area. The SCI may have the fixed frequency locations.

These schemes can also work at the SCI transmission without a FDM. In other words, the frequency limit domain for one SCI transmission can be whole bandwidth.

Based on the conditions, for scheme 1 (indication displayed), there can be no limit that the time and frequency domain of SCI has fixed mapping relation with SL-PRS resource location. The SCI may obtain the time and frequency of the SL-PRS. For the FDM or comb pattern of the SL-PRS, the REoffset list or other frequency index list can be included in the SCI.

In FIG. 7, one SCI (SCI 1 & 2) may contain/include frequency list information which can indicate SL-PRS1 and SL-PRS2.

For scheme 2 (implicit indication), a time and frequency domain of SCI may have fixed mapping relation with a SL-PRS resource location (e.g., taking the max port 2 as an example in FIG. 7). If the SCI 1 & 2 is transmitted in the fixed area, the SL-PRS1 and SL-PRS2 can be determined in the mapping area. The SL-PRS1 can be transmitted by port 1, and the SL-PRS2 can be transmitted by port 2. In other words, if there are no signal or channel transmit in the resource area of SL-PRS1 and SL-PRS2 for the UE, the UE may not transmit anything in the resource of SCI 1 & 2. The SCI transmission candidate location can be mapping with the multi-port SL-PRSs transmission.

Scheme 3: joint the scheme 1 and scheme 2. For example, SCI resource location may map the time domain of PRS. If the SCI 1 & 2 has been dedicated, there can be a transmission in the time domain of SL-PRS1 or SL-PRS2. The SL-PRS that is transmitted can be obtain from the frequency index list (or REOffset, port ID, or panel ID).

The SCI, comb pattern, and the FDM resource offset/index have mapping relations. For the number of these factors, the x SCI(s) can map y comb patterns, and the y comb pattern can map z FDM resource offset list. A FDM resource offset list may contain at least one of the offset, where x, y, and z can be integers.

### Implementation Example 4

For a resource pool to transmit a SL-PRS, a bandwidth of SL-PRS can be seem as the bandwidth of resource pool, or smaller than the bandwidth of resource pool. In certain embodiments, the bandwidth of SL-PRS can be smaller than the bandwidth of resource pool.

### Case 1: SL-PRS Semi-Static Configuration

FIG. 8 is a diagram illustrating an example SL-PRS semi-static configuration, according to various arrangements. In a dedicated resource pool, the SL-PRSs can be transmitted and received with the different bandwidths. The bandwidths can be several candidate values (e.g., Subbands in FIG. 8). The bandwidths can be (pre-)configured from a higher layer. The bandwidth list parameters of SL PRSs can be (pre-)configured from a higher layer. The bandwidth can be indicated by a lower layer, such as SCI. After the UE receives and decodes the SCI, the UE may determine the SL-PRS resource location.

For this case, the SL-PRS may also be FDM (e.g., SL-PRS4 can be FDM with another SL-PRS1 in the same resource pool). The two dedicated resource pool can be similar (e.g., one for SL-PRS4 and another for SL-PRS1).

### Case 2: SL-PRS Dynamic Configuration

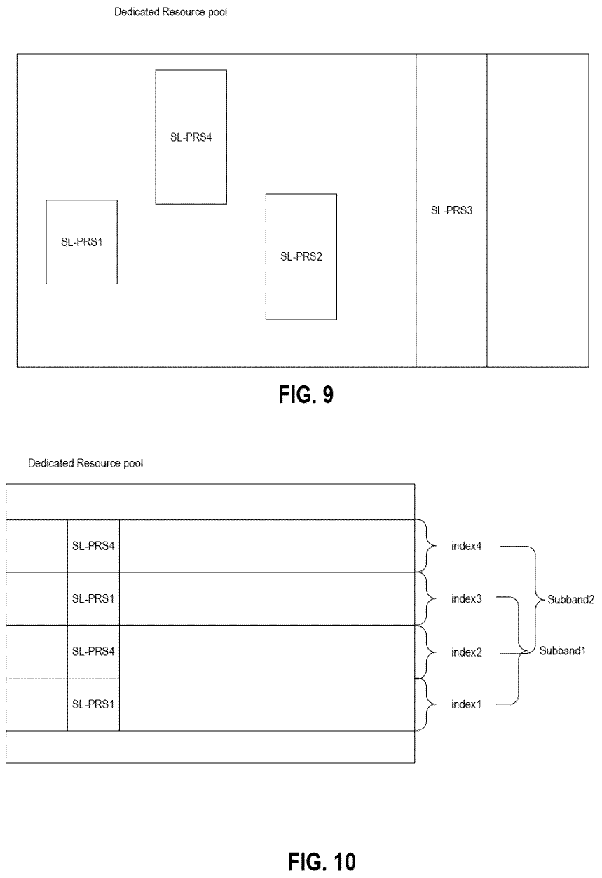

FIG. 9 is a diagram illustrating an example SL-PRS dynamic configuration, according to various arrangements. In a dedicated resource pool, the SL-PRSs can be transmitted and received with the different bandwidths. The bandwidths of SL PRSs can be flexible. The bandwidths can be (pre-)configured from a lower layer, such as SCI indicated. After the UE receives and decodes the SCI, the UE may determine the SL-PRS resource location.

For this case, a starting PRB index and the PRB length of SL-PRS may be included in SCI. The parameters of SL PRS can be indicated by a lower layer.

### Implementation Example 5 (Frequency Resource Allocation for SL-PRS)

For a frequency domain in a resource pool, the frequency of SL-PRS can be continuous or discontinuous. A granularity can be resource element (RE), resource block (RB), subchannel, interlace, or other granularity (e.g., Sub band). The granularity may include a comb pattern, an interlace, or a hopping. The granularity of the frequency domain can be the same as the time domain.

For example, the SL-PRS can be transmitted from different sub-band which can be continuous (FIG. 8) or discontinuous (FIG. 10) frequency granularity in the dedicated resource pool. FIG. 10 is a diagram illustrating an example discontinuous (or interlace) SL-PRS, according to various arrangements. In order to receive the SL-PRS, the lower layer may be aware of/know which frequency domain transmits the SL-PRS.

In the resource pool, a frequency division multiplexing (FDM) can be supported for reference signal (RS) or channel (CH) (e.g., physical sidelink control channel (PSCCH)/physical sidelink shared channel (PSSCH), physical sidelink feedback channel (PSFCH)). For a dedicated resource pool, the frequency division multiplexing can be supported by the subband1 and subband4 in FIG. 8 or the subband1 and subband2 in FIG. 10.

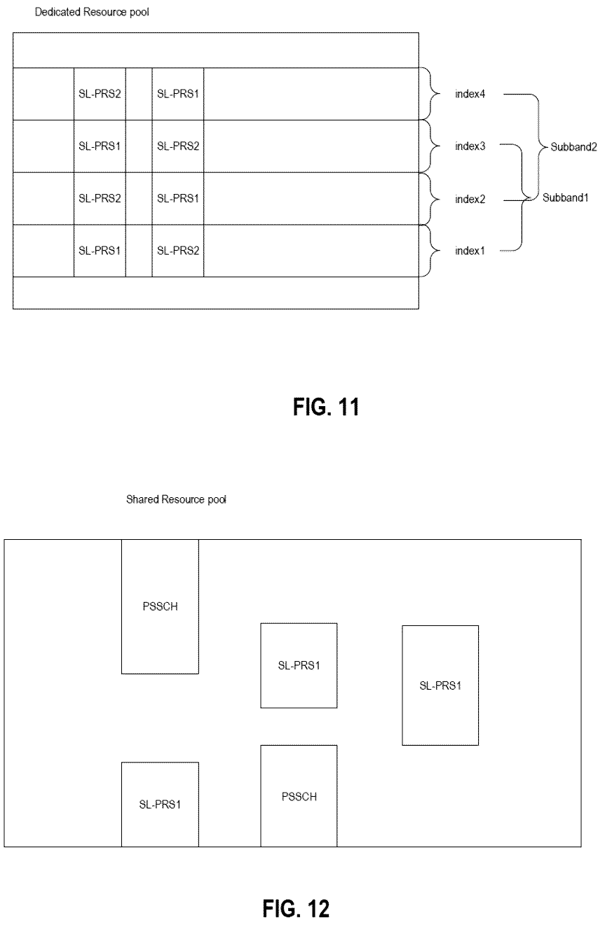

Furthermore, a hopping can be support for the RS or CH transmission. For example, the SL-PRS1 can transmit in subband1 and can hop in the frequency of subband2 in FIG. 11 (for the dedicated resource pool). In other ways, a comb pattern can be seen/identified as an hopping rule.

A comb pattern, interlace pattern, or hopping rule/pattern can be seen/identified as a subband with discontinuous frequency granularity.

Method 1: The subband pattern, comb pattern, or interlace pattern can be (pre-) configured by a high layer. The lower layer can contain/include an indicator of the pattern or subband index. The mapping relation can be (pre-)configured by a higher layer information element (IE). For a physical layer, only index concept may be concern. A higher layer can also provide lists of pattern, and/or SCI first choice of the patterns from the lists. The higher layer may indicate an index/offset of the resource location.

Method 2 (a more flexible method): The pattern (including the comb pattern, interlace pattern, and/or hopping rule/pattern) in a physical layer IE may indicate the resource locations. If the pattern has been (pre-)configured in the higher layer, the frequency index (for physical layer) can be seen/identified as a continuous index to indicate. FIG. 11 is a diagram illustrating an example SL-PRS comb or hopping pattern, according to various arrangements. For example as shown in FIG. 11, based on the method 1, the physical layer may indicate subband1 (e.g., the frequency domain of index 1 and index 3). For another example as shown in FIG. 11, based on the method 2, the physical layer may first provide a pattern illustration, and may indicate the index/offset of the pattern.

### Implementation Example 6

In this implementation example, a flexible pattern based the method 2 in the implementation example 5 is discussed, taking hopping as an example. It can be also suitable for a comb pattern or an interlace.

For a shared resource pool, type A SCI may indicate the PSSCH, and the Type B SCI may indicate the SL-PRS. When a UE plans to transmit a SL-PRS (based on mode2 sensing), a reservation resource for PSSCH can be known. A flexible hopping based on the physical layer for the SL-PRS can avoid the PSSCH resource location (as shown in FIG. 12). The hopping can be inter band or intra band in the same resource pool or different resource pool.

### Implementation Example 7

A SL-PRS transmission in a dedicated resource pool may have a relation with a PSSCH transmission in a SL resource pool. In the dedicated resource pool for SCI and/or SL-PRS transmission, there may be no PSSCH resource. Therefore, the higher layer IE transmission may be contained/included in an associated PSSCH.

For example, a timing relationship for SL-PRS and associated PSSCH can be concerned/discussed. The associated PSSCH can be earlier than a SL-PRS transmission. Based on information of the associated PSSCH, the SL-PRS can be received correctly.

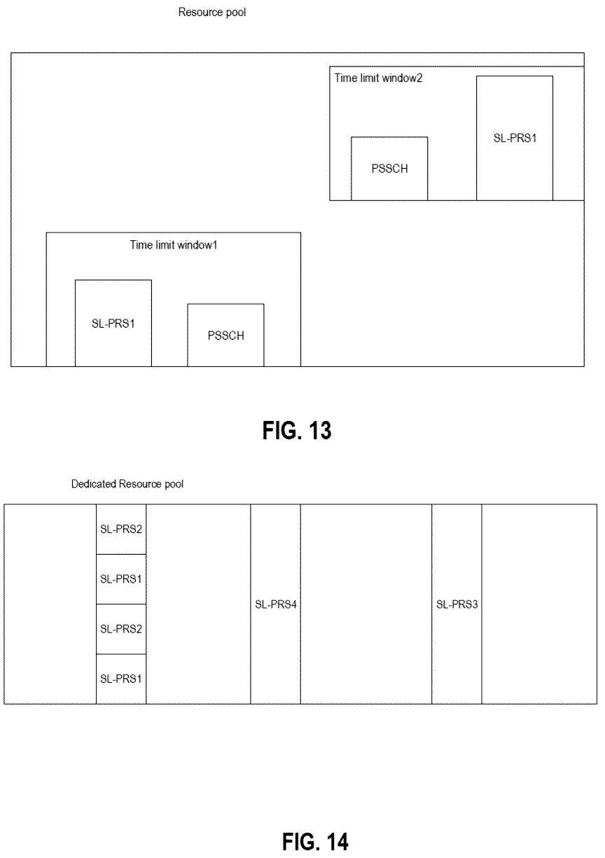

Alternatively, the associated PSSCH transmission can be not far from the SL-PRS. There can be a limit in time window for SL-PRS and the associated PSSCH transmission (as shown in FIG. 13).

For a multi-port and FDM transmission, the SL-PRS and the associated PSSCH can transmit by different ports at the same time. It can be the same for the SL-PRS and the associated PSSCH that are transmitted in the shared resource pool.

### Implementation Example 8 (Sensing)

Based on a sensing method in sidelink, a time domain granularity can be a slot, and a frequency domain granularity can be subchannel. For a SL-PRS sensing (based on the comb pattern), if a UE transmits SL-PRS in the comb pattern resource area, the UE may receive the SCI or SL-PRS and may select a resource to transmit.

Scheme 1: For the comb pattern sensing, the UE may not distinguish an offset (REoffset list or index list) in the comb pattern. For SL mode 2 sensing, if a UE receives the SCI or SL-PRS to reserve the resource in the comb pattern, the UE may not select the resource based on the comb pattern.

Scheme 2: Based on the scheme 1, there can be some enhancement methods. For a periodic or repetition SL-PRS transmission, hopping in symbol/slot level or comb REoffset list changing can be used for different periodic or repetition times, which may enhance a reliability of the SL-PRS transmission.

Scheme 3: For the comb pattern sensing, a UE may distinguish the offset/offset list (REoffset or index list) in the comb pattern. For SL mode 2 sensing, if a UE receives the SCI or SL-PRS to reserve the resource in the comb pattern, the UE may select the resource of the comb pattern based on the comb REoffset (list).

First, for a SCI designing and FDM transmission, REoffset(list) or symbolOffset(list) can be introduced.

Mode 2 sensing procedures can be modified for SL-PRS sensing. The original sensing reference signal received power (RSRP) may further consider an occupancy of the comb pattern. A REoffset occupancy list or more small granularity resource RSRP can be considered. The resource can be considered unavailable only when the number of additional combs is full, or the remaining comb offset in the comb pattern is less than the number of PRSs to be sent.

FIG. 14 is a diagram illustrating an example SL-PRS sensing, according to various arrangements. Based on scheme 1, if a UE 1 transmits or reserves a SL-PRS1 resource location, a UE2 may not transmit a SL-PRS on the SL-PRS2 resource location based on the mode 2 sensing and the comb pattern.

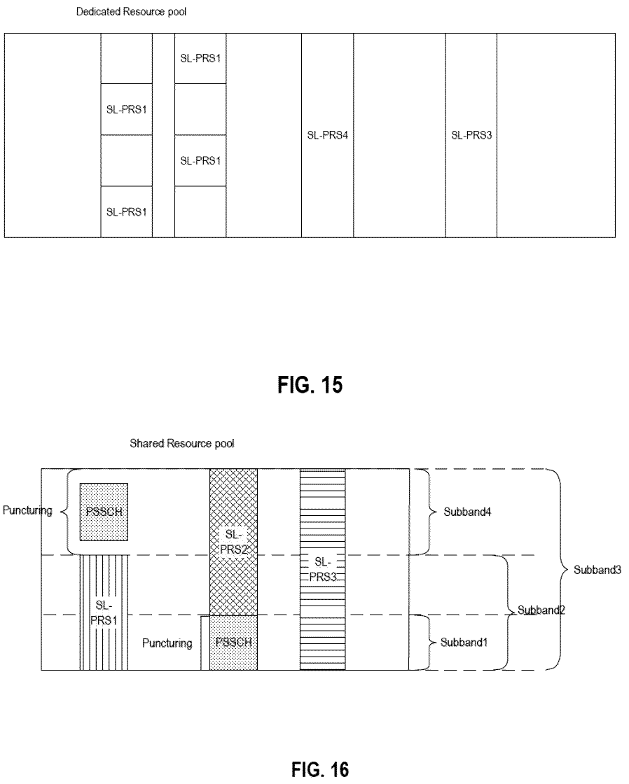

Furthermore, based on scheme 2, for enhancement methods of scheme1, the SL-PRS1 periodic or repetition can be seen/identified as hopping in different subband/frequency granularity or different comb RE offset transmission in symbol/slot level (as shown in FIG. 15). If the SL-PRS1 resource location is transmitted or reserved, there may be no SL-PRS transmission between upper SL-PRS1 and lower SL-PRS1 in FIG. 15.

Based on scheme 3, if a UE1 transmits or reserves SL-PRS1 resource location based on the mode 2 sensing and REoffset from SCI, a UE2 may know/be aware of that the SL-PRS2 resource location have not been occupied. The UE2 can reserve or transmit the SL-PRS in the SL-PRS2.

### Implementation Example 9

A time granularity of puncturing can be a symbol level or a slot level. For a shared resource pool, a UE can be puncturing at some fixed domain, such as a puncturing pattern. One or more fixed frequency domain or granularity can be punctured. FIG. 16 is a diagram illustrating an example SL-PRS fixed puncturing in a shared resource pool, according to various arrangements. The puncturing granularity can be subband in a resource pool, which may contain/include one or more sub-channels. A SL-PRS1 transmission can be with the subband4 puncturing because there are PSSCH transmissions or preserved. For SL-PRS3, the UE may know/be aware of that there is no PSSCH transmission or reservation. There can be no puncturing for SL-PRS3. In certain embodiments, more than one frequency domain or granularity can be punctured.

The puncturing pattern can be (pre-)configured or from a higher layer. The pattern can be static, semi-static, or dynamic. The puncturing means the resource may be dropped, and the UE does not receive theses puncturing resources.

For a SL-PRS repetition, a periodic transmission, or a different SL-PRS in the resource pool, the actual bandwidth of SL-PRSs can be the same or not. For a SL-PRS fixed puncturing, a same number of puncturing may mean/indicate the same actual bandwidth of SL-PRSs. If there is a different number of puncturing of these SL-PRS, there can be a power control problem. There can be two solution for this problem.

Case 1: A total power is constant in one slot or one occasion. It may mean/indicate that there are more puncturings for a SL-PRS, which may increase the higher power of non puncturings' parts. A total power for sending the at least one SL-PRSs is constant in one slot or one occasion.

Case 2: A power per RE/RB/subchannel is constant in one slot or one occasion. It may mean/indicate more puncturings for a SL-PRS, which may decrease/lower/reduce a total total power for SL-PRS. A power for sending the at least one SL-PRS per each resource element/resource block/subchannel/sub-band is constant in one slot or one occasion.

For the shared resource pool, the UE puncturing domain may not be fixed. One or more flexible frequency domain or granularity can be punctured, which may have higher bandwidth efficiency and more flexible puncturing for SL-PRS transmission.

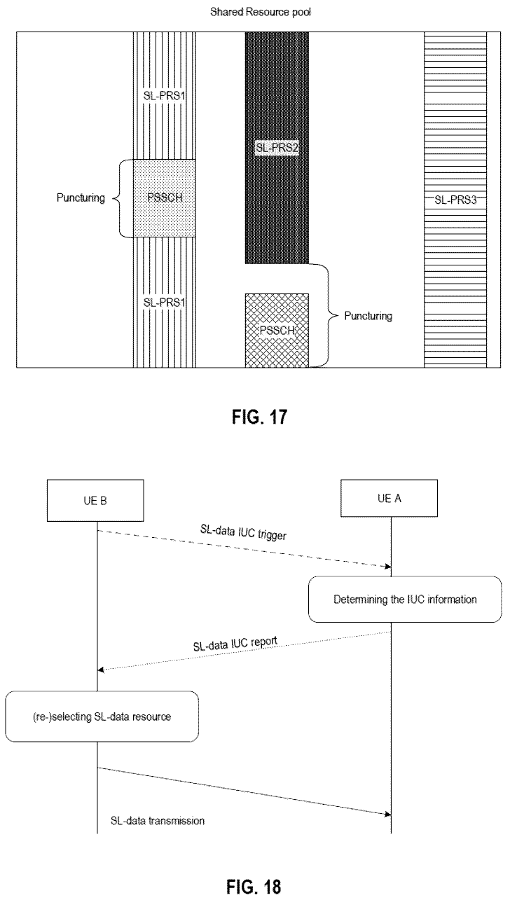

FIG. 17 is a diagram illustrating an example SL-PRS fixed puncturing in a shared resource pool, according to various arrangements. The puncturing granularity can be sub-channel, which is based on the granularity of the resource pool. One puncturing may contain/include one or more continues sub-channels, which is based on the PSSCH or other conflict/reservation. In certain embodiments, one or more puncturing can be with a SL-PRS. SL-PRS1 transmission can be with one puncturing because there are one PSSCH transmission is preserved.

In order to make the SL-PRS have same actual bandwidth, for the SL-PRS2, the puncturing frequency can be higher than the reservation of PSSCH and the puncturing for SL-PRS2 can be same as SL-PRS1. For a SL-PRS3, the UE may know/be aware of that there are no PSSCH transmission or reservation. There can be no puncturing for SL-PRS3. The actual bandwidth of SL-PRS3 can be bigger than SL-PRS1 and SL-PRS2.

For a SL-PRS repetition, a periodic transmission, or a different SL-PRS in the resource pool, the actual bandwidth of SL-PRSs can be the same or not. For a SL-PRS flexible puncturing, the different total frequency length puncturings of these SL-PRS may have a power control problem. For this problem, there can be two ways to solve.

Case 1: A total power is constant in one slot or one occasion. It may mean/indicate that there are more puncturings for a SL-PRS, which may increase the higher power of non puncturings' parts. A total power for sending the at least one SL-PRSs is constant in one slot or one occasion.

Case 2: A power per RE/RB/subchannel is constant in one slot or one occasion. It may mean/indicate more puncturings for a SL-PRS, which may decrease/lower/reduce a total total power for SL-PRS. A power for sending the at least one SL-PRS per each resource element/resource block/subchannel/sub-band is constant in one slot or one occasion.

### Implementation Example 10

For SL-PRS fixed Puncturing or flexible puncturing, the puncturing information may be known for a SL-PRS receiver UE. A transmitter UE may inform messages which can be contained/included in the higher layer or physical layer.

For example, the fixed puncturing candidate area can be included in the higher layer. The physical layer may indicate which puncturing index is used. For the flexible puncturing, one or more SCI can indicate the puncturing information, including the punctured/dropped resources and/or residual resources and/or original resources of SL-PRS.

The puncturing information may contain/include at last one of the following: a puncturing indicator (e.g., puncturing or not); a puncturing type (e.g., fixed puncturing or flexible puncturing); a puncturing number (e.g., puncturing number); a puncturing length(list)-TimeDomain (e.g., the puncturing length(list)); a puncturing StartSymbol(list)-TimeDomain (e.g., Start symbol (slot or other time granularity)); a puncturing EndSymbol(list)-TimeDomain (e.g., End symbol (slot or other time granularity)); a puncturing length(list)-FrequencyDomain (e.g., the puncturing length(list)); a puncturing StartSub-channel(list)-FrequencyDomain (e.g., Start symbol (slot or other Frequency granularity)); a puncturing EndSub-channel(list)-Frequency Domain (e.g., End symbol (slot or other Frequency granularity)); a puncturing TRIV(list) (e.g., one or more puncturing position in TimeDomain); a puncturing FRIV(list) (e.g., one or more the puncturing position in FrequencyDomain); a puncturing CombOffset (e.g., indicate the comb pattern); a puncturing ask (e.g., the transmitter UE may ask the receiver UE puncturing information (if the puncturing is allowed or not)); or a puncturing report (e.g., answer the puncturing ask). One or more of these component can used for punctured/dropped resources and/or residual resources and/or original resources of SL-PRS.

A puncturing triggering can be triggered by an explicit request or triggered by a condition other than explicit request. For the explicit request, the UE can contain the request in SCI or higher layer (MAC CE, SLPP). For triggered by a condition (e.g., based on the mode2 sensing method), the UE may select x % (e.g., 20%) resource for SL-PRS transmission, even if the 20% resource may have a conflict (e.g., the 20% is more suitable than other 80% based mode2 sensing). The SL-PRS may have a larger frequency domain than PSSCH. The 20% resource may have a conflict with the PSSCH.

Scheme 1: According to the 20% resource obtained RSRP threshold, the max RSRP limit threshold, the puncturing may be triggered (e.g., if the RSRP threshold of 20% is higher than the max RSRP limit).

Scheme 2: According to a first random transmission of SL-PRS, the UE may determine if a conflict exists. If there is a conflict, the puncturing may be triggered on the selection resource area. If there is no conflict, the puncturing may not be triggered on the selection resource area.

Scheme 3: According to the CR/CBR from the resource pool. For a dedicated resource, the CR/CBR may be included. For a shared resource pool, the CR/CBR may consider the influence of SL-PRS.

When the UE receive the SL-PRS based on the SCI, the UE may decode the SCI, and/or may get/obtain/determine the puncturing information from the SCI or the higher layer. Based on these puncturing information, the UE may receive/determine information regarding to the SL-PRS.

For example, a Rx UE can receive SL-PRS by using 1 bit indicator in the SCI and the puncturing information from other UE's SCI (e.g., IUC UE's SCI 2C, IUC UE can contain the receiver UE).

### Implementation Example 11

For the schemes about puncturing, a main purpose is to avoid possible conflicts. For a UE which may transmit the SL-PRS (or other signal/CH), the UE can obtain conflicts/reservations according to the sensing scheme. The conflicts/reservations can be from the inter-UE coordination (IUC). FIG. 18 is a diagram illustrating an example inter-UE coordination (IUC) scheme for SL-data, according to various arrangements. For a SL-PRS transmission, the inter-UE coordination (IUC) may be introduced.

FIG. 18 shows a procedure of (re-)selection SL-data (PSCCH/PSSCH/PSFCH) resource (or SL-PRS resource). Based on the UE A's IUC report about the conflict/reservation of SL-data (PSCCH/PSSCH/PSFCH) or SL-PRS, the UE B may transmit the SL-PRS (or SL-data) with SCI indication the puncturing information to other UE (e.g., UE A can also be the receiver UE).

For the dedicated resource pool, the coordination UE can provide information about the SL-PRS for transmission. For the comb pattern of SL-PRS, the inter-UE coordination can provide the comb RE offset as a puncturing information. The UE may puncture the selection resource based on the conflict/reservation information from the IUC or transmitter UE's sensing.

For the shared resource pool, the coordination UE can provide information about the SL-PRS and PSSCH or other RS/CH for transmission. Based on the information, the transmitter UE may puncture and/or notify the puncturing information to the receiver UE by the SCI.

It should be understood that one or more features from the above implementation examples are not exclusive to the specific implementation examples, but can be combined in any manner (e.g., in any priority and/or order, concurrently or otherwise).

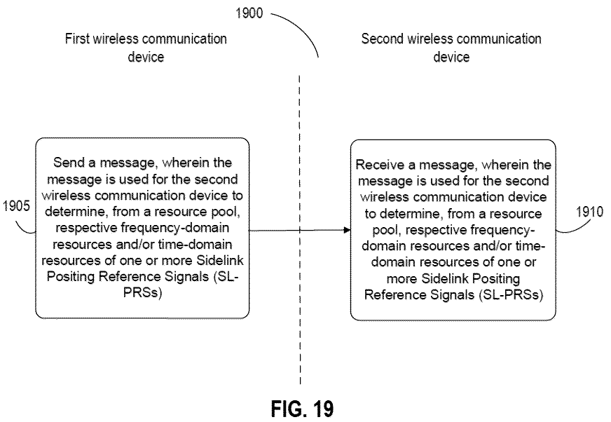

FIG. 19 illustrates a flow diagram for sidelink positioning, in accordance with an embodiment of the present disclosure. The method 1900 may be implemented using any one or more of the components and devices detailed herein in conjunction with FIGS. 1-18. In overview, the method 1900 may be performed by a first wireless communication device, in some embodiments. Additional, fewer, or different operations may be performed in the method 1900 depending on the embodiment. At least one aspect of the operations is directed to a system, method, apparatus, or a computer-readable medium.

Some arrangements of the present disclosure relate to systems, methods, apparatuses, and non-transitory computer-readable media relating to sending, by a first wireless communication device (e.g., TX UE) to a second wireless communication device (e.g., RX UE), a message. The message can be used for the second wireless communication device to determine, from a resource pool, respective frequency-domain resources and/or time-domain resources of one or more Sidelink Positing Reference Signals (SL-PRSs).

Some arrangements of the present disclosure relate to systems, methods, apparatuses, and non-transitory computer-readable media relating to receiving, by a second wireless communication device from a first wireless communication device, a message. The message can be used for the second wireless communication device to determine, from a resource pool, respective frequency-domain resources and/or time-domain resources of one or more Sidelink Positing Reference Signals (SL-PRSs).

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method, comprising:
sending, by a first wireless communication device to a second wireless communication device, a message that contains one or more Sidelink Control Information (SCI) messages,
wherein transmission candidate locations of the one or more SCI messages are mapped to locations of the respective frequency-domain resources and/or time-domain resources of the one or more SL-PRSs, and
wherein the message is used for the second wireless communication device to determine, from a resource pool, respective frequency-domain resources and/or time-domain resources of one or more Sidelink Positing Reference Signals (SL-PRSs).

2. The wireless communication method of claim 1, wherein a pattern of the one or more SL-PRSs is (pre-)configured in one of following layers: Radio Resource Connection (RRC) layer, Sidelink Sidelink Positioning Protocol (SLPP), PC5 Radio Resource Control (PC5-RRC), PC5 Signalling (PC5-S), Medium Access Control (MAC) layer, or Application layer.

3. The wireless communication method of claim 1, wherein the one or more SCI messages are used to indicate at least one of the frequency-domain resources or time-domain resources of the SL-PRSs, the frequency-domain resource and/or time-domain resource of at least one of the SL-PRSs to be punctured, residual frequency-domain resources and/or residual time-domain resources of the SL-PRSs after being punctured, or frequency-domain resources and/or time-domain resources of PSSCH.

4. The wireless communication method of claim 1, wherein a transmission candidate location of at least one of the one or more SCI messages is (pre-)configured.

5. The wireless communication method of claim 1, wherein the one or more SL-PRSs are Frequency Domain Multiplexed.

6. The wireless communication method of claim 1, wherein the one or more SCI messages explicitly configure the respective frequency-domain and/or time-domain resources of the SL-PRSs.

7. The wireless communication method of claim 6, wherein the respective frequency-domain resources of the SL-PRSs, (pre-)configured by the one or more SCI messages, include at least one of: one or more RE offsets, one or more symbol or slot offsets, one or more sub-channel offsets, or one or more frequency indices.

8. The wireless communication method of claim 1, wherein the one or more SCI messages implicitly configure the respective frequency-domain and or time-domain resources of the SL-PRSs.

9. The wireless communication method of claim 8, wherein the one or more SCI messages have a (pre-)configured mapping with the frequency-domain and/or time-domain resources of the SL-PRSs.

10. The wireless communication method of claim 1, wherein the message is (pre-)configured to determine one of a plurality of patterns (pre-)configured for the plurality of SL-PRSs, and wherein the patterns are (pre-)configured in one of the following layers: RRC layer, SLPP, PC5-RRC, PC5-S, MAC layer, or Application layer.

11. The wireless communication method of claim 10, wherein the message includes one or more Sidelink Control Information (SCI) messages.

12. The wireless communication method of claim 10, wherein the one or more SCI messages explicitly configure the respective frequency-domain and/or time-domain resources of the SL-PRSs.

13. The wireless communication method of claim 12, wherein the respective frequency-domain resources of the SL-PRSs, (pre-)configured by the one or more SCI messages, include at least one of: one or more RE offset lists, one or more sub-channel offset lists, or one or more frequency index lists.

14. The wireless communication method of claim 10, wherein the one or more SCI messages implicitly configure the respective frequency-domain and/or time-domain resources of the SL-PRSs.

15. The wireless communication method of claim 14, wherein the one or more SCI messages have a (pre-)configured mapping with the frequency-domain and/or time-domain resources of the SL-PRSs.

16. A first wireless communication device, comprising:
at least one processor configured to:
send, via a transmitter to a second wireless communication device, a message that contains one or more Sidelink Control Information (SCI) messages,
wherein transmission candidate locations of the one or more SCI messages are mapped to locations of the respective frequency-domain resources and/or time-domain resources of the one or more SL-PRSs,
wherein the message is used for the second wireless communication device to determine, from a resource pool, respective frequency-domain resources and/or time-domain resources of one or more Sidelink Positing Reference Signals (SL-PRSs).

17. A wireless communication method, comprising:
receiving, by a second wireless communication device from a first wireless communication device, a message that contains one or more Sidelink Control Information (SCI) messages,
wherein transmission candidate locations of the one or more SCI messages are mapped to locations of the respective frequency-domain resources and/or time-domain resources of the one or more SL-PRSs,
wherein the message is used for the second wireless communication device to determine, from a resource pool, respective frequency-domain resources and/or time-domain resources of one or more Sidelink Positing Reference Signals (SL-PRSs).

18. A second wireless communication device, comprising:
at least one processor configured to:
receive, via a receiver from a first wireless communication device, a message that contains one or more Sidelink Control Information (SCI) messages,
wherein transmission candidate locations of the one or more SCI messages are mapped to locations of the respective frequency-domain resources and/or time-domain resources of the one or more SL-PRSs,
wherein the message is used for the second wireless communication device to determine, from a resource pool, respective frequency-domain resources and/or time-domain resources of one or more Sidelink Positing Reference Signals (SL-PRSs).
